(19) United States
(12) Patent Application Publication
(10) Pub. No.: US 2003/0141638 A1
(43) Pub. Date: Jul. 31, 2003

(54) Air damper for mobile furniture parts

(76) Inventor: Luciano Salice, Carimate (IT)

Correspondence Address: Rocco S. Barrese, Esq., DILWORTH & BARRESE, LLP, 333 Earle Ovington Blvd., Uniondale, NY, 11553, US

(21) Appl. No.: 10/317,383

(22) Filed: Dec. 12, 2002

(30) Foreign Application Priority Data
Dec. 12, 2001 (DE) 201 20 112.7

(51) Int. Cl. B60G 11/56; F16F 11/00

(52) U.S. Cl. 267/34; 267/71; 267/226

(57) ABSTRACT

The invention relates to an air damper for mobile furniture parts, such as drawers or doors, consisting of a cylinder that is open at one end and a piston with seal that is movable in the longitudinal direction in this cylinder and that is connected to a ram. According to the invention, there is a small drilled hole provided in the outer wall of the cylinder near the closed end section of the cylinder.

The invention relates to an air damper for mobile furniture parts, such as drawers or doors, consisting of a cylinder that is open at one end and a piston with seal that is movable in the longitudinal direction in this cylinder and that is connected to a ram.

Dampers for mobile furniture parts are fundamentally already known in different designs. For example, European patent application 01 111 420 4 discloses a braking device for furniture parts, wherein this, i.e., the damper is filled with a highly viscous fluid.

It is already known from the prior art to use air dampers instead of the damping devices filled with a highly viscous fluid. Examples are JP 0060272446 AA and EP 0 430 797 A1 as well as EP 0 841 452 A2, DE 44 09 716 A1, and DE 37 29 597 A1.

However, the known devices either require expensive manufacturing procedures or a high degree of precision. Some of these air dampers are equipped with adjustable valves for setting the compression pressure while the other air dampers have expensive grooves or channels on the wall of the piston or cylinder, which can quickly lead to damage to the piston seal.

The object of the present invention is to create an air damper for mobile furniture parts, more particularly for drawers or doors, that has a particularly simple design and can be manufactured economically.

To solve the object according to the invention, a generic air damper according to the features of claim 1 is manufactured. According to the characteristic, a generic air damper is equipped with a drilled hole in the outer cylinder surface, located near the closed end section of the cylinder, whose diameter is substantially smaller than the diameter of the cylinder. Experiments have shown that this design according to the invention provides a very good braking effect, wherein it is essential for the invention that the drilled hole is located in the outer cylinder surface and not in the bottom of the cylinder. If a corresponding drilled hole is provided in the bottom of the cylinder, the result is a substantially inferior brake effect.

The drilled hole is most advantageously approximately 2.5% to 4%, preferably 3.3%, of the cylinder diameter. This size ratio results in a particularly good damping behaviour.

Preferably, the piston of the air damper can be moved back to its extended position by a return device after it is inserted into the cylinder. A suitable return device would be a spring or a suitable magnet. By analogy with the German utility model DE 201 17 031, the cylinder may be a telescopic cylinder with at least two sections.

It is particularly advantageous if a buffer is attached to the free end of the ram. The ram can particularly advantageously consist of two crosswise bars. In one of the bars of the ram, there may be a slotted hole through which a pin engages, whereby the pin is stationary in the cylinder. Through the contact of the pin with the ends of the slotted hole, the relative motion between the ram and the cylinder is limited.

According to a particularly advantageous design of the invention, the movable cylinder of the telescopic cylinder has at least two radially protruding crosspieces on its circumference which allow it to be guided inside the stationary cylinder along at least one pin that is stationary in the cylinder. According to a modification, four radially protruding crosspieces may be provided here, guided along two opposing pins, which are stationary inside the cylinder. These pins, stationary in the cylinder, can be inserted in the corresponding drilled holes in the cylinder.

According to another preferred design of the invention, the piston may have a groove, which is conically shaped towards the end of the piston and in which an O-ring seal is loosely suspended so that it forms a seal in the direction of insertion of the piston and is loose in the direction of extraction.

In another preferred embodiment of the invention, the outer cylinder surface has at least two sections with different inner diameters, the ram connected to the piston has at least one section with a diameter that is matched to the inner diameter of the section of the cylinder, wherein the ram has a second seal that seals it off from the outer cylinder surface. The said second seal substantially improves the effect of the first seal, located in the area of the piston, so that the compressed air is forced to escape exclusively through the drilled hole in the end section of the cylinder.

Other preferred designs of the embodiment with one outer cylinder wall having different sections with different diameters can be seen in the dependent claims 12 to 15, following the dependent claim 11.

Further details and advantages of the invention will be further explained in detail with reference to the embodiments shown in the figures. It is shown in:

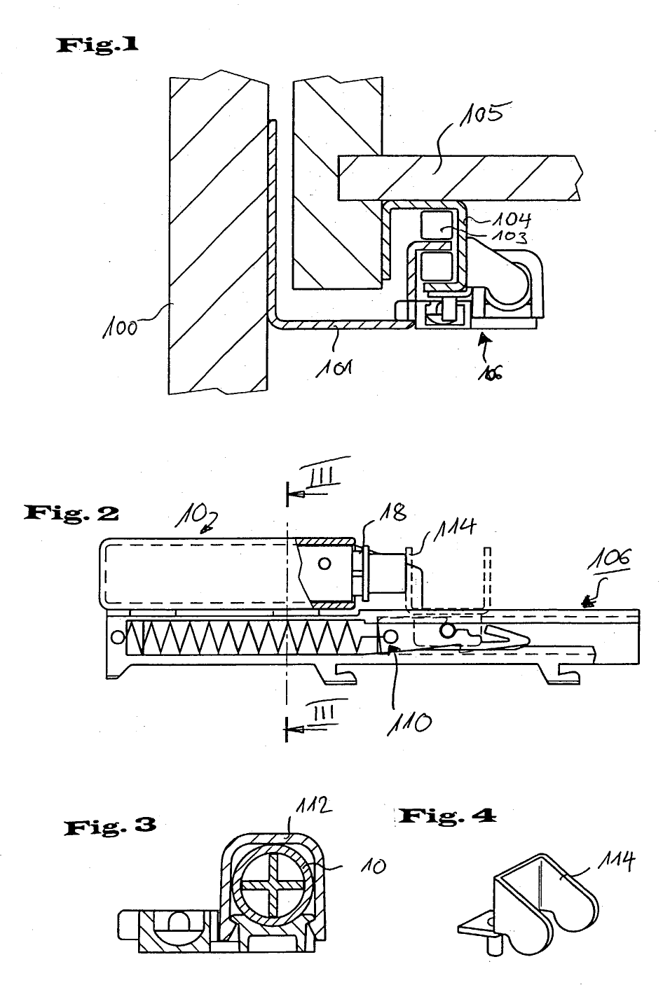

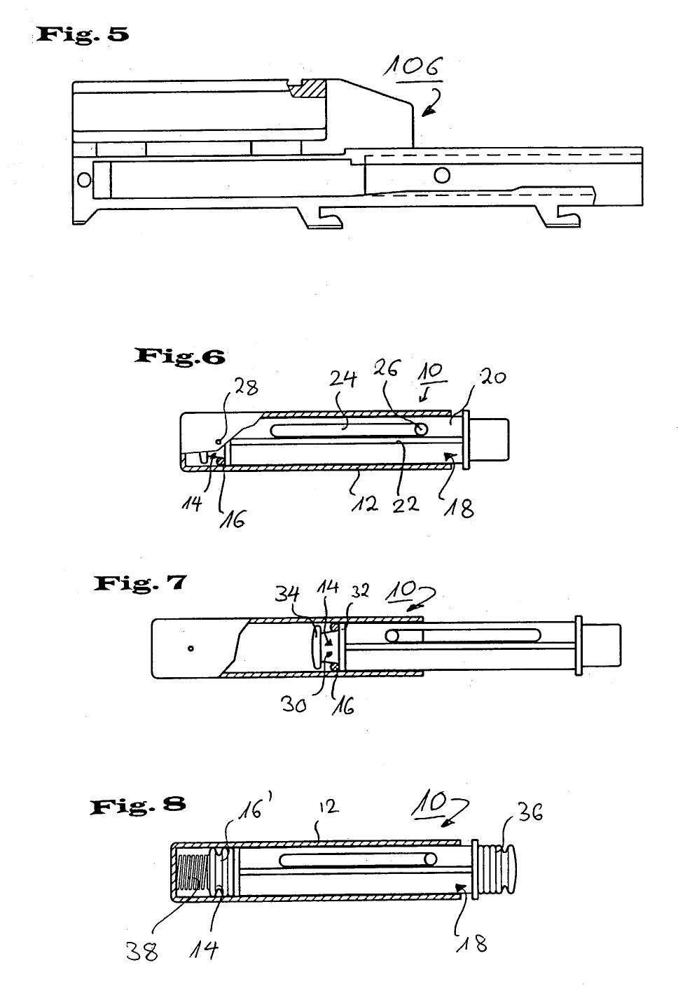

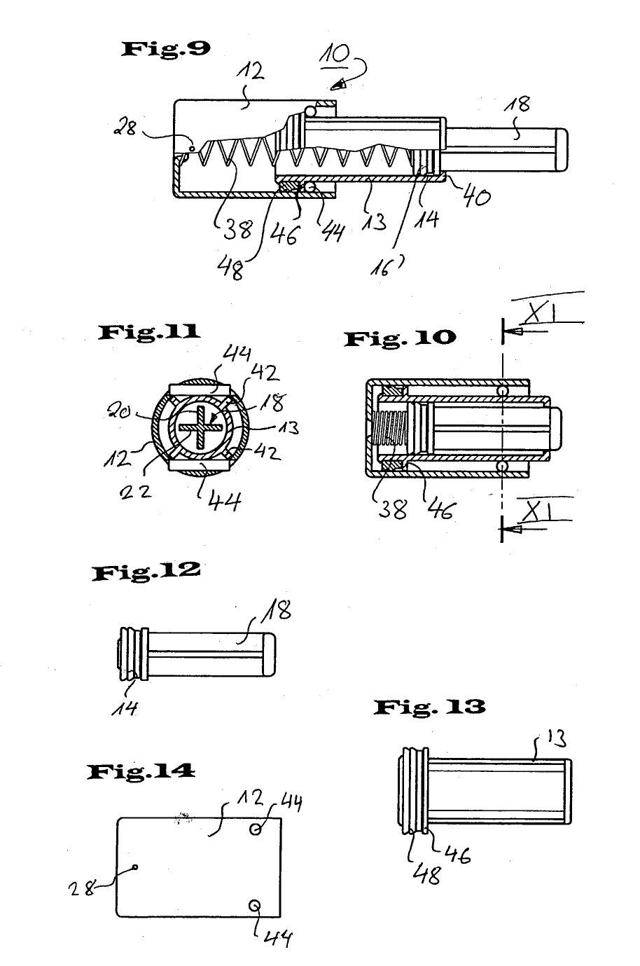

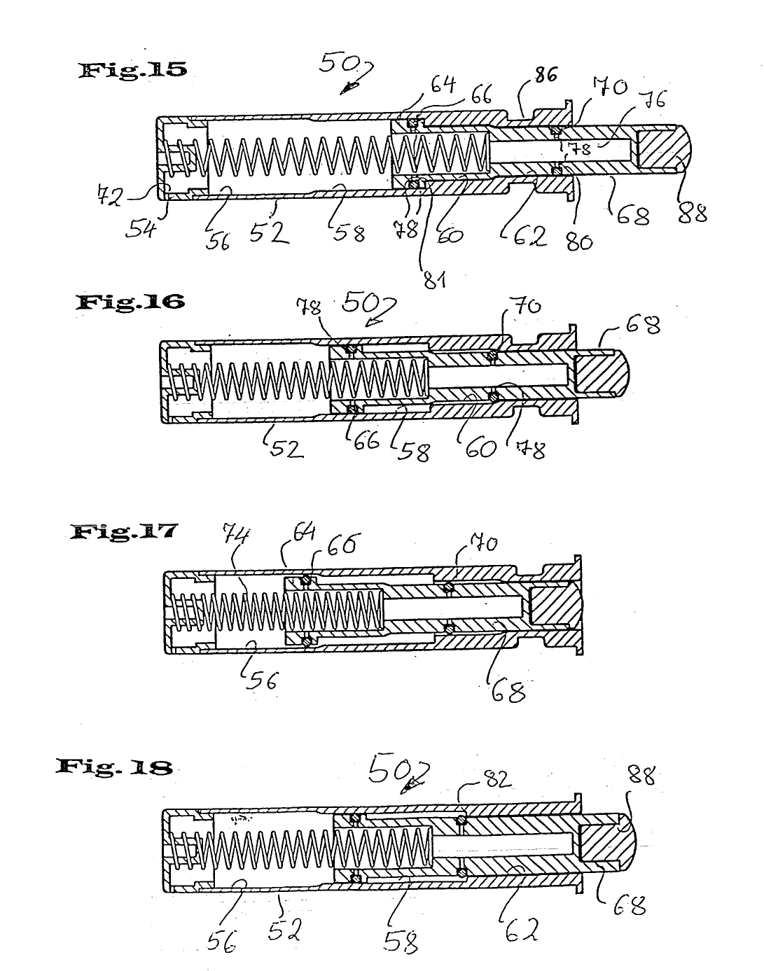

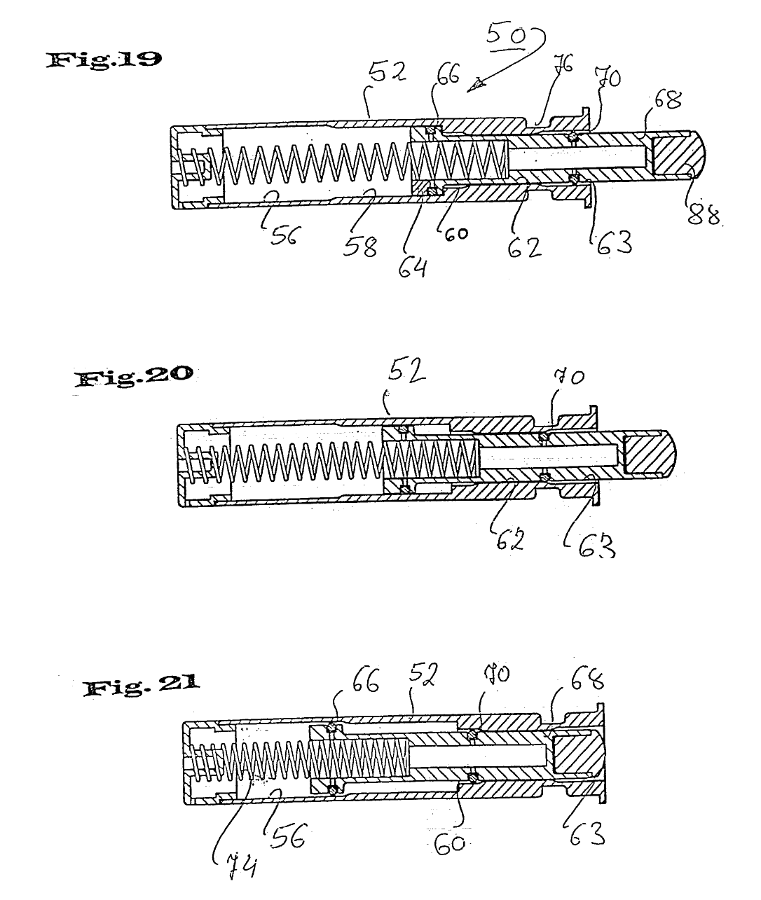

FIGS. 1 to 5: partially cutaway views showing the air cylinder according to the invention used in an application built into a drawer guide,

FIG. 6: a partially cutaway side-view of an air cylinder according to an embodiment of the present invention,

FIG. 7: an air cylinder according to the representation according to FIG. 6 in the extended state,

FIG. 8: an air cylinder in a side cutaway view according to an alternative embodiment,

FIG. 9: an air cylinder in a side cutaway view according to an another embodiment of the invention,

FIG. 10: a cutaway view of the air cylinder according to FIG. 9 in the compressed state,

FIG. 11: a cross-sectional view along the intersection line XI-XI according to FIG. 10,

FIG. 12: the ram with piston according to an embodiment of the invention,

FIG. 13: the mobile intermediate cylinder in a side view,

FIG. 14: a side view of a cylinder of the air damper according to the invention,

FIGS. 15-17: a side cutaway view of an air cylinder according to another embodiment of the invention in different positions.

FIG. 18: another embodiment of an air cylinder according to the invention, also in a side cutaway view, and

FIGS. 19-21: another embodiment of an air cylinder according to the invention in a side cutaway view in different positions.

The basic construction of the air damper according to the invention can be shown by the example according to the FIGS. 6 and 7. In this first embodiment of FIGS. 6 and 7, the air damper 10 consists of a cylinder 12, closed at one end, in which a piston 14 is movable in the longitudinal direction. The cylinder 14 has a seal 16. A ram 18 consisting of two crosspieces 20 and 22, respectively, is joined in one piece to the cylinder 14. In the crosspiece 20, is located a slotted hole 24 in which a pin 26, stationary with respect to the cylinder engages. The pin 26, which is stationary in the cylinder, together with the slotted hole 24 limits the pushed-in or extended positions of the piston 14, wherein the pushed-in position is shown in FIG. 6 and the extended position is shown in FIG. 7. Particularly important for the damping is the drilled hole 28 in the outer surface of the cylinder 12, near its closed end. The diameter of the drilled hole 28 is preferably 3.3% of the inner diameter of the cylinder 12. In the embodiment according to FIGS. 6 and 7, the piston 14 has a groove 30, which runs conically towards the end of the piston 14. There is a seal 16, which is designed as an O-ring, suspended in the groove 30 with a diameter chosen in such a manner that it rests against a flange-like stop 32 while the piston is being pushed in and is extended so far on the cone-shaped groove that the O-ring forms a tight seal with the inside cylinder wall when the piston is pushed in. On the other hand, when the piston is pulled out, the O-ring slides in the opposite direction along the cone-shaped groove and makes contact with the flange-like end 34 of the piston 14. By this means, the piston 14 can be pulled to the outside completely freely, wherein this can be accomplished, for example, by a magnet on the far end of the ram 18, not described in detail here.

The effect of this design of the air damper according to FIGS. 6 and 7 is based on the fact that only a small amount of compressed air at a time can escape through the drilled hole 28 per unit time because of its small diameter so that a good damping effect can be achieved here. In the opposite direction, i.e. when the piston 20 is pulled out, the air can flow more freely through both the drilled hole and the loose connection between the conical groove 30 and the O-ring 16.

FIG. 8 shows another embodiment of the air damper 10. The cylinder 12 is constructed in the same manner here. The ram 18 also corresponds to the construction according to the embodiment in FIGS. 6 and 7. Only the piston 14 has a seal 16′ of a different shape. At the far end of the ram 18, a buffer 36 is connected. Between the bottom of the cylinder 12 and the ram 18, a compression spring 38 is installed, providing the necessary restoring force for the return of the piston 14.

FIGS. 9 to 14 show a telescope-like design of the air damper 10, which basically corresponds to the design of the damper according to the German utility model 201 17 031.0 by the same applicant, wherein the damping drilled hole 28 for the air is provided not in the top wall of the piston and in the cap but rather in the outer cylinder surface of the outer cylinder 12 according to the present invention. As shown in FIG. 9, the piston 14 is guided inside an intermediate cylinder 13, which in turn acts like a telescope in the cylinder 12. The piston 14 with ram 18 is returned by a compression spring 38, shown in the extended position in FIG. 9 and in the compressed position in FIG. 10. Again, the ram 18 has a cross-shaped cross section in this embodiment, as can be seen in FIG. 11. The length of the crosspieces 20 and 22 of the ram 18 is shorter than the diameter of the piston 14 so that, in its starting position, it is in contact with a coupling 40 on the front of the mobile intermediate cylinder 13. The mobile intermediate cylinder 13 has four radially protruding crosspieces 42, which are used to guide it in the cylinder 12. Pins 44 are incorporated in the cylinder 12 as a guide, as can be seen in FIG. 11. These pins 44, as a result of the protruding crosspieces 42 attached to this intermediate cylinder, prevent the intermediate cylinder 13 from being turned inside the cylinder 12. The mobile intermediate cylinder 13 is also provided with a flange-like rim 46, which rests against the pins 44 inserted in corresponding drilled holes of the cylinder 12 in the starting position, as shown in FIG. 9. The piston 14 is provided with a seal 16′, and the mobile intermediate cylinder 13 is provided with a seal 48. In the outer surface of the cylinder 12, there is the drilled hole 28. The spring 38 is located between the bottom of the cylinder 12 and the piston 14. FIG. 12 shows the piston 14 with ram 18 in a detailed view. FIG. 13 shows the mobile intermediate cylinder 13 with flange 46 and seal 48, and FIG. 14 shows the cylinder 12 with the drilled hole 28 and the two receiving holes for the pins 44.

The air dampers described by FIGS. 6 to 14 can be used for damping furniture parts, for example, drawers in drawer guides. An application is shown in FIGS. 1 to 5. This application corresponds to that of the European patent application 11 11 420.4 by the same applicant. The variant shown there included a hydraulic damper. In the embodiment shown here, this is replaced by an air damper according to one of the present embodiments, as can be seen in FIGS. 2 and 3.

The installation example for an air damper 10 is described briefly in the following, where reference is made to European patent application 01 111 420.4 for the detailed description of this installation state. FIG. 1 shows a furniture body wall 100, to which a guide rail 101 is screwed. On this guide rail, an extendable rail 104 is guided with rollers or ball bearings 103, wherein the extendable guide rail 104 is permanently connected to a drawer 105. Connected to the body-side guide rail 101 is subunit 106 in which the air damper 10 on the one hand and an automatic spring-loaded drawer retraction system 110 are located. The operation of this automatic retraction system is described in detail in EP 01 111 420.4, to which reference is made here. At the end of the spring-loaded retraction of the drawer, the retraction shock of the drawer 105 against the body 100 is dampened by the air damper 10. The cutaway view III-III according to FIG. 2, shown in FIG. 3, shows the construction of the air damper, suspended in a box-like receptacle 112. When the movable drawer is retracted, the ram 18 hits a stop 114 which is shown again in a perspective view in FIG. 4. FIG. 5 shows the casing of the subunit 106 without the automatic retraction system 110 or the air damper 10.

An air damper 50 according to the embodiment shown in FIGS. 15, 16, and 17 is substantially formed by a cylinder 52 that is closed by a lid 54 on one side. The inside wall of the outer surface of the cylinder 52 is divided into four section 56, 58, 60, and 62 with different diameters (cf. FIGS. 15, 16, and 17). A piston 64 has a seal 66. The piston 64 is connected in one piece to a ram 68 which has another seal 70 approximately in the middle of the piston. In the extended position shown in FIG. 15, the seals 66 and 70 are in the sections 58 and 62 of the outer surface of the cylinder 52. In this position, the seals make a seal, wherein they especially display their sealing effect if a furniture part presses against the ram 68 so that the air can escape only through the corresponding drilled hole 72.

If the ram 68 is pushed into the position seen in FIG. 16, the seal 70 enters the cylinder section 60, which has a larger diameter than the circumference of the seal 70 so that the seal 70 looses its effect and, as a result, the braking force of the entire air damper 50 is reduced. The seal 66, however, is still effective in this position because it is still located in the section 58 of the tube 62. In the pushed-in position according to FIG. 17, however, the seal 60 is also pushed into another section, namely section 56, that has a larger diameter than the diameter of the seal 60. The entire sealing effect of both seals, namely seal 66 and seal 70, is therefore cancelled. Therefore, only the spring 74 exerts a counterforce on the piston 64 or the ram 68. In this position, the device exerting the necessary closing force of a furniture part can thus be used most effectively in this position according to FIG. 17 because the force exerted against the closing force is smallest in this case.

In the embodiment shown here according to FIGS. 15 to 17, the ram 68 may have a cavity 76 that is connected to the grooves 80, 81 for the seals 70 and 66, respectively, via channels 78.

FIG. 18 shows a simplified embodiment of an air damper 50, in which the outer wall of the cylinder 52 only has sections 56, 58, and 62. The intermediate section 60 is not shown in this embodiment. The ram 68 also does not have two sections with different diameters but here has only one diameter over its entire length. In this embodiment, the section 58 therefore takes over the function of section 58 and of the intermediate section 60 according to the previously described embodiment according to the FIGS. 15 to 17. The stroke of the piston 68, as in the previous variant, is limited by a discontinuous transition in the form of a step or a base section 82.

The piston 68, as in the previous model, is limited by a discontinuous transition in form of a step or a basement 82.

FIGS. 19 to 21 show another alternative embodiment, wherein the outer wall of the cylinder 52 of an air damper 50 is divided into five sections, namely the sections 56, 58, 60, 62, and 63. Apart from that, the air damper 50 is designed in the same manner as in the embodiment according to FIGS. 15 to 17. Next to the section with smaller diameter, with which the second seal 70 thus makes tight contact (cf. FIG. 20), there is a section 63 on the outside with a relatively larger diameter. The diameter of the section 63 corresponds to that of the section 60. Thus, in the first phase of pushing in the ram 68, as shown in FIG. 19, only the seal 66 in the area of the piston 64 is effective, but not the seal 70 in the area of the ram 68 because inside the section 63 in the cylinder 52 this does not make a tight seal with the outside wall of the cylinder 52. While the piston is being pushed in, as shown in FIG. 20, the seal 70 then makes tight contact inside the section 62 however, so that the damping action is increased here due to the better sealing effect.

In FIG. 21, as the ram 68 is pushed in further, the seal 70 now enters the section 60, the diameter of which corresponds to the section 63. The sealing effect of the seal 70 is cancelled again. At the same time, the seal 66 is moved into the section 56 of the cylinder 52 so that the seal 66 also is no longer in contact with the outer wall. In this position, the counterforce on the ram 68 is exerted only by the spring 74. Other features that are obvious from the figures, such as a groove 86 (cf. FIG. 15 or FIG. 19, respectively) to fasten the cylinder 52 to a frame or the attachment of a buffer 88 to the free end of the ram 68, are generally known and are not described in detail here.

1. An air damper for mobile furniture parts, such as drawers or doors, consisting of a cylinder that is open at one end and a piston with seal that is movable in the longitudinal direction in this cylinder and that is connected to a ram, characterized by
a drilled hole in the outer cylinder surface, located near the closed end section of the cylinder, wherein the diameter of the drilled hole is substantially smaller than the diameter of the cylinder.

2. The air damper according to claim 1, characterized in that the drilled hole has a diameter that is 2.5% to 4%, preferably 3.3% of the diameter of the cylinder.

3. The air damper according to claim 1 or claim 2, characterized in that the piston can be moved back to its extended position by a return device after it has been inserted into the cylinder.

4. The air damper according to claim 3, characterized in that the return device is a spring or a magnet.

5. The air damper according to one of claims 1 to 4, characterized in that the cylinder is a telescopic cylinder with at least two stages.

6. The air damper according to one of claims 1 to 5, characterized in that there is a buffer at the free end of the ram.

7. The air damper according to one of claims 1 to 6, characterized in that the ram is made up of two crosspieces.

8. The air damper according to claim 7, characterized in that in one of the crosspieces of the ram, a slotted hole is formed through which a pin engages, the pin being stationary in the cylinder.

9. The air damper according to claim 5, characterized in that the movable cylinder of the telescopic cylinder has at least two radially protruding crosspieces on its circumference which allow it to be guided inside the stationary cylinder along at least one pin that is stationary in the cylinder.

10. The air damper according to one of the claims 1 to 9, characterized in that the piston has a groove that runs conically towards its end, in which an O-ring seal is loosely suspended so that it makes a tight seal when the piston is pushed in and is loose when the piston is retracted.

11. The air damper according to one of claims 1 to 10, characterized in that the outer cylinder surface has at least two sections with different inner diameters, the ram connected to the piston has at least one section whose diameter is matched to the inner diameter of a section of the cylinder, and the ram has a second seal that seals it off from the outer cylinder surface.

12. The air damper according to claim 11, characterized in that the outer wall of the cylinder has a first section with a diameter larger than the diameter of the piston including the seal, that the outer wall of the cylinder has a second section with a diameter chosen such that the piston with the seal makes a tight seal, whereas the ram with the seal has a comparatively smaller diameter and that the outer wall of the cylinder has a third section with a diameter such that the ram with its seal makes a tight seal.

13. The air damper according to claim 12, characterized in that between the second and the third section of the outer wall of the cylinder, there is an intermediate section with a diameter to which the diameter of a first section of the ram is matched, while this diameter of the intermediate section is larger than the diameter of the seal on a second section of the ram.

14. The air damper according to claim 12, characterized in that between the second and third section of the outer wall of the cylinder and next to the third section on the outside, there are other sections with diameters chosen such that they are larger than the diameter of the seal on the ram.

15. The air damper according to claim 14, characterized in that the additional sections of the outer wall of the cylinder have the same diameters.
